(19) United States
(12) Patent Application Publication
(10) Pub. No.: US 2017/0185141 A1
(43) Pub. Date: Jun. 29, 2017

(54) HAND TRACKING FOR INTERACTION FEEDBACK

(71) Applicant: Microsoft Technology Licensing, LLC, Redmond, WA (US)

(72) Inventors: Jamie Daniel Joseph SHOTTON, Cambridge (GB); Andrew William FITZGIBBON, Cambridge (GB); Jonathan James TAYLOR, London (GB); Richard Malcolm BANKS, Egham (GB); David SWEENEY, London (GB); Robert CORISH, London (GB); Abigail Jane SELLEN, Cambridge (GB); Eduardo Alberto SOTO, Ontario (CA); Arran Haig TOPALIAN, London (GB); Benjamin LUFF, Dundee (GB)

(21) Appl. No.: 14/982,911

(22) Filed: Dec. 29, 2015

(51) Int. Cl. G06F 3/01; G06T 19/00; G06F 3/16; G06T 7/00

(52) U.S. Cl. CPC G06F 3/011; G06T 7/0042; G06T 19/006; G06F 3/16; G06F 3/016; G06T 2207/30196; G06T 2200/04

(57) ABSTRACT

Apparatus is described which has a memory configured to receive captured sensor data depicting at least one hand of a user operating the control system. The apparatus has a tracker configured to compute, from the captured sensor data, values of pose parameters of a three dimensional (3D) model of the hand, the pose parameters comprising position and orientation of each of a plurality of joints of the hand A physics engine stores data about at least one virtual entity. The physics engine is configured to compute an interaction between the virtual entity and the 3D model of the hand based at least on the values of the pose parameters and data about the 3D model of the hand A feedback engine is configured to trigger feedback to the user about the computed interaction, the feedback being any one or more of visual feedback, auditory feedback, haptic feedback.

### BACKGROUND

Systems in which a user is able to control one or more virtual entities using their hands give the potential for users to operate game systems, augmented reality systems, virtual reality systems and others in a natural manner Humans are used to interacting with physical objects using their hands and learn to do so from an early age with considerable skill and dexterity.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

An apparatus is described which has a memory configured to receive captured sensor data depicting at least one hand of a user operating the control system. The apparatus has a tracker configured to compute, from the captured sensor data, values of pose parameters of a three dimensional (3D) model of the hand, the pose parameters comprising position and orientation of each of a plurality of joints of the hand. A physics engine stores data about at least one virtual entity. The physics engine is configured to compute an interaction between the virtual entity and the 3D model of the hand based at least on the values of the pose parameters and data about the 3D model of the hand. A feedback engine is configured to trigger feedback to the user about the computed interaction, the feedback being any one or more of visual feedback, auditory feedback, haptic feedback.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a person wearing a virtual reality headset in order to play a virtual piano;

FIG. 2 is a schematic diagram of a virtual hand playing a virtual piano;

FIG. 3 is a schematic diagram of a virtual hand deforming a virtual entity;

FIG. 4 is a schematic diagram of a virtual figurine attached to real hands of a user;

FIG. 5 is a schematic diagram of a tracker, a physics engine and a feedback engine whereby a user controls a downstream system with his or her hand(s);

FIG. 6 is a flow diagram of a method at the tracker, physics engine and feedback engine of FIG. 5;

FIG. 7 is a flow diagram of a method of operation at a tracker;

FIG. 8 is a graph of tracker performance;

FIG. 9 is a flow diagram of a method of calibrating shape parameters;

FIG. 10 illustrates an exemplary computing-based device in which embodiments of a hand tracker, physics engine and feedback engine are implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of operations for constructing and operating the example. However, the same or equivalent functions and sequences may be accomplished by different examples.

An apparatus which enables a user to accurately manipulate one or more virtual entities using his or her hand(s) is described. Sensor data is captured such as depth images, color images, raw time of flight data, scanner data and others. The sensor data is used for accurate tracking of pose parameters of a plurality of joints of a three dimensional (3D) hand model. Together with a physics engine this enables fine-scale manipulation of one or more virtual entities in a natural, intuitive manner

A virtual entity is a computer-generated representation of all or part of an object, person, animal, surface, or other entity.

A physics engine is computer software and/or hardware/firmware which computes simulations of physical systems, by using rules or criteria which describe any one or more of rigid body dynamics, soft body dynamics, fluid dynamics and others. Rigid body dynamics are representations of the movement of systems of interconnected bodies (such as objects, surfaces) under the action of forces, where the bodies are rigid which means that they do not deform under the action of applied forces. Soft body dynamics are representations of the movement of systems interconnected bodies (such as objects, surfaces) under the action of forces, where the bodies are soft which means they they deform under the action of applied forces.

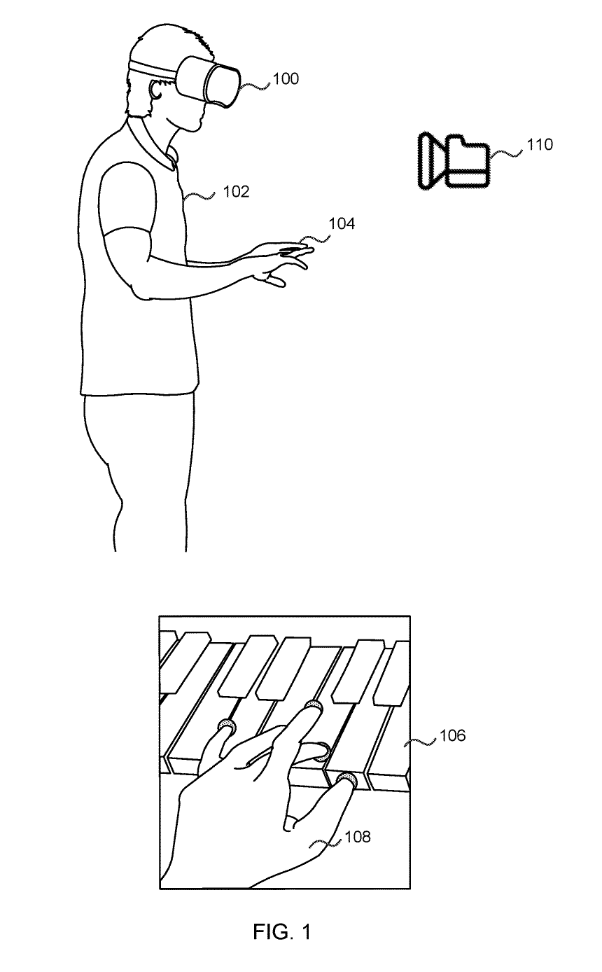

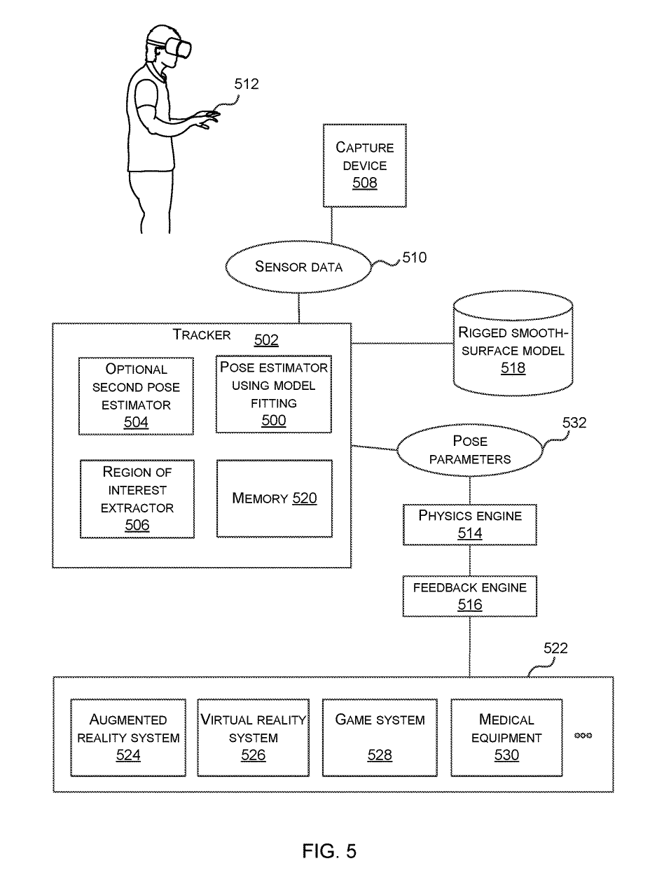

FIG. 1 is a schematic diagram of a user 102 wearing a virtual reality headset 100 in order to play a virtual piano 106 with avatar hands 108. Although FIG. 1 is discussed with respect to a virtual reality headset 100 the technology is not limited to virtual reality as explained in more detail with respect to FIG. 5 below. In this example a virtual reality system implemented using a computing device is integral with the headset 100 or at another computing device in wired or wireless communication with the headset. A capture device 110 located in the room captures sensor data of the user 102 and his hands 104. The user 102 has positioned his hands 104 and is moving his fingers as if he were playing a piano keyboard located in front of him.

The capture device 110 is any sensor which is able to capture data depicting the user 102. A non-exhaustive list of examples is: depth camera, raw time of flight sensor, depth scanner, laser range finder, color camera, video camera, web camera, medical imaging device, or other capture device. The capture device 110 in this example is room-mounted. However, it is also possible to use a head mounted capture device or a body worn capture device. More than one capture device is available in some examples.

A tracker receives the sensor data from the capture device 110 and computes values of pose parameters of a 3D model of a hand. The 3D model is of a generic hand in some examples. In other examples the 3D model of the hand is calibrated to fit the shape of the hand of the individual user 102. For an individual hand the pose parameters comprise position and orientation of individual ones of a plurality of joints of a hand

A physics engine uses the values of the pose parameters to render the virtual piano 106 and avatar hand 108. Because of the accuracy and detail of the values of the pose parameters the apparatus achieves fine-scale, naturalistic manipulation of the virtual piano 106 and avatar hand 108 via motion and articulation of the fingers and hands 104. In some examples, shape parameters of the 3D model are computed from the sensor data and this further enhances accuracy of the control.

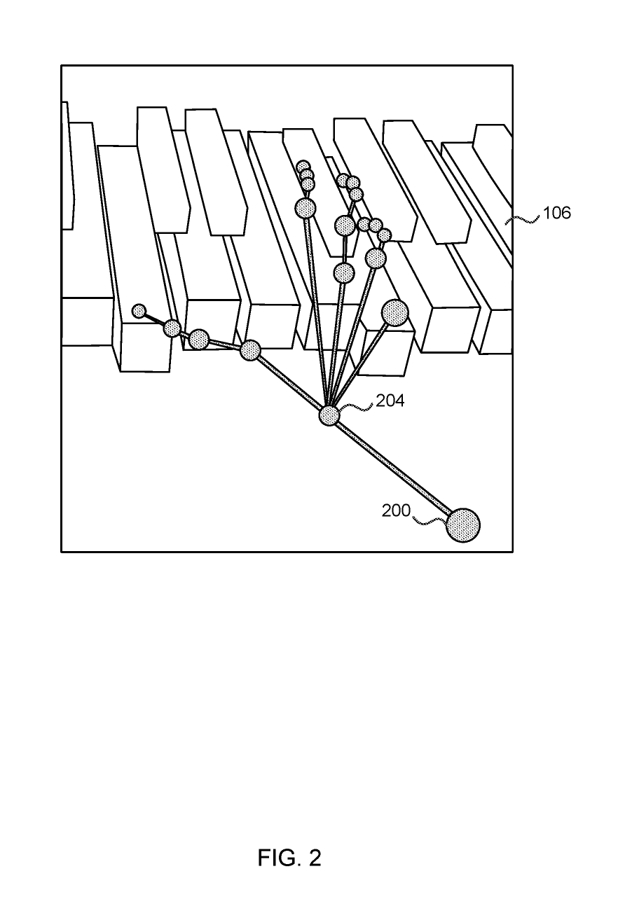

FIG. 2 is a schematic diagram of a virtual hand playing a virtual piano 106. In this example the 3D model of the hand is a rigged model which is a model that has an associated skeleton. In the example of FIG. 2 the skeleton and at least some of the joints of the skeleton 200, 204 are visible although a surface of the model, such as a smooth-surface or a polygon mesh surface are not visible.

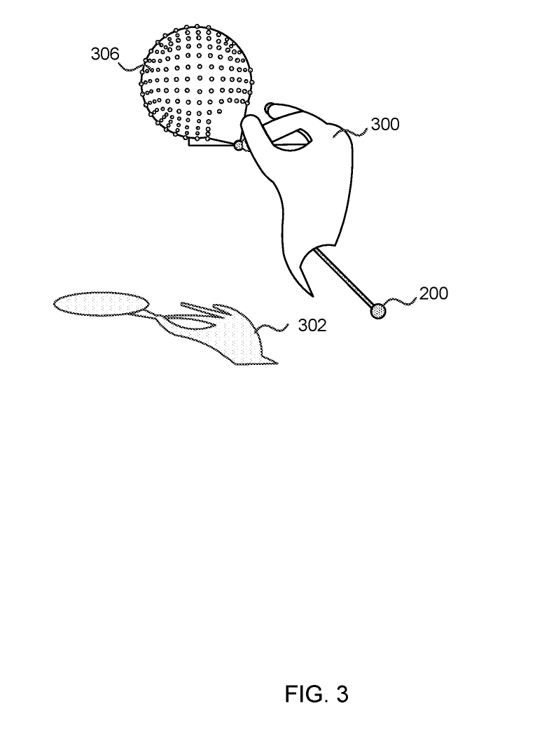

The physics engine has knowledge of the 3D model of the hand and it applies the pose parameter values that it receives to the 3D model. It computes interactions between the 3D hand model (with the pose parameter values applied) and the virtual piano 106 using a plurality of rules describing how objects interact, such as how frictional forces apply, how forces of gravity apply and others. In the example of FIG. 2 rigid body dynamics are used by the physics engine. However, soft body dynamics are used in some examples as described with reference to FIG. 3.

The physics engine sends data about the computed interaction to a feedback engine (described in more detail below). The feedback engine triggers provision of feedback to the user about the computed interaction. For example, the feedback is visual and auditory feedback in the situation of FIG. 2. The feedback engine triggers a graphics engine to render the virtual keyboard and the avatar hands. The feedback engine triggers a loudspeaker to output sounds of the keys being played.

FIG. 3 is a schematic diagram of a virtual hand 300 deforming a virtual entity 306 which is a deformable sphere with a plurality of small protrusions on its surface. The virtual hand is shown as a posed 3D rigged smooth-surface model with an associated skeleton of which a single joint 200 is visible. The model is posed as values of the pose parameters have been applied to the model which put the virtual hand into the position and orientation shown (as opposed to a generic or default position and orientation). The virtual hand is in a virtual environment such that a shadow 302 of the hand is visible.

A user is operating a virtual reality system which is creating the display visible in FIG. 3. One or more capture devices capture sensor data of the user's hand reaching to pluck one of the protrusions on the surface of the virtual sphere 306. As the user plucks one of the protrusions the virtual sphere is deformed as illustrated. This happens because the physics engine uses soft body dynamics for the virtual sphere 306 together with the tracked pose parameter values. The physics engine computes an interaction between the virtual hand 300 and the virtual sphere 306 according to the pose parameter values and the 3D model.

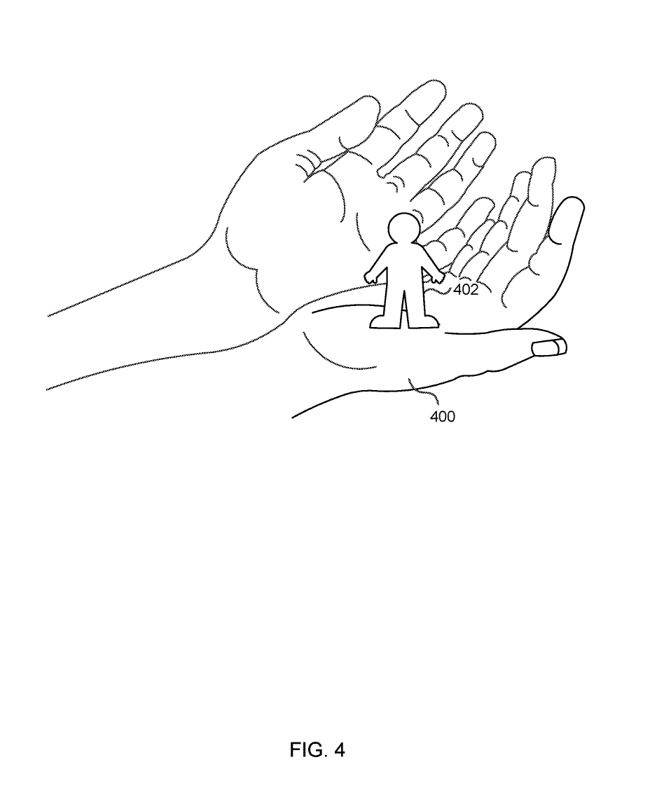

In the examples of FIG. 1 and FIG. 2 a virtual reality system is used. It is also possible to have an augmented reality system. For example, FIG. 4 is a schematic diagram of a virtual figurine attached to real hands of a user. In this example a user is wearing an augmented reality headset comprising a capture device which captures sensor data depicting the user's hands. The user is able to see her own hands 400 and also to see a virtual reality figuring 402 in her palm. The virtual reality figurine 402 is created by rendering a display of the virtual reality figurine 402 using the augmented reality headset. The virtual reality figurine is computed using the physics engine so as to take into account interaction with a 3D model of the real hands for which pose parameter values are computed as described herein. In some examples the augmented reality system is configured so that the virtual reality figurine is rendered on the user's hands 400 despite movements of the user's real fingers and real hands 400. In this way the virtual figurine appears attached to the user's hands but able to move over the surface of the hands and fingers.

FIG. 5 is a schematic diagram of a tracker 502, a physics engine 514 and a feedback engine 516 whereby a user controls a downstream system 522 with his or her hand(s). The downstream system is any computer-implemented apparatus which is controlled by the user's tracked hands, using touch-less input in many examples. A non-exhaustive list of examples of a downstream system is augmented reality system 524, virtual reality system 526, game system 528, medical equipment 530, and others. The tracker 502 uses a rigged smooth-surface model 518 in this example.

A rigged model is one which has an associated representation of one or more joints of the articulated object, such as a skeleton. In various examples in this document a smooth surface model is one where the surface of the model is substantially smooth rather than having many sharp edges or discontinuities; it has isolated nearly smooth edges in some examples. In other words, a smooth surface model is one where derivatives of the surface do not change substantially anywhere on the surface. This enables a gradient based optimizer to operate as described in more detail below. A sharp edge is one in which the rate of change of surface position or orientation changes substantially from one side of the edge to another such as the corner of a room where two walls are joined at 90 degrees. A nearly smooth edge is one in which the rate of change of surface position or orientation changes suddenly but by a negligible amount, from one side of the edge to the other. For example, a mesh model is not a smooth surface model since there are generally many sharp edges where the mesh faces join.

A capture device 508 such as a color camera, depth camera, a sensor which captures 3D point clouds, or other type of sensor captures data depicting one or more hands 512 (of one or more users) in an environment. The captured sensor data 510 such as an image or 3D point cloud or other sensor data 510 is input to a tracker 502 using a wired or wireless link, over a communications network or in other ways.

The tracker 502 is computer implemented for example in a mobile phone, in a virtual reality headset, in a personal computer, in a game system, in medical equipment or in other apparatus depending on the application domain concerned. The tracker 502 has access to a store holding a rigged smooth-surface model 518 of a generic hand. For example, the rigged smooth-surface model 518 is stored at the mobile phone, medical equipment, game system or other device. The rigged smooth-surface model 518 is stored at a remote location accessible to the tracker 502 over a communications network in some examples.

The tracker computes values of pose parameters 520 of the rigged smooth-surface model 518 which fit the captured sensor data 510. It is able to do this for a single instance of the captured sensor data 510. In some examples the tracker computes a stream of values of the pose parameters 520 as a stream of captured data 510 is input to the tracker 502. In this way the tracker 502 follows pose of the hand(s) as it moves and/or as the capture device 508 moves. The computed values of the pose parameters 520 are input to a physics engine 514. The physics engine computes an interaction between a virtual entity and a 3D model of the user's hand, using the pose parameters, and a feedback engine 516 triggers feedback about the interaction to be presented to the user, via a downstream apparatus 522 being controlled by the user's hands. Examples of downstream apparatus include but are not limited to: an augmented reality system 524, a natural user interface 526, a game system 528, medical equipment 530 or others.

The tracker 502 itself comprises a pose estimator which uses model fitting 500, an optional second pose estimator 504 using another type of tracking technology, and optionally a region of interest extractor 506. The tracker 502 is computer-implemented using software and/or hardware/firmware. It comprises a memory 520 which stores sensor data 510 received from capture device 508.

The feedback engine 516 and the physics engine 514 are also computer implemented using software and/or hardware/firmware. The feedback engine takes as input interactions, computed by the physics engine, between a virtual entity and the rigged smooth-surface model 518. For example, an interaction is a specification of changes in the position and orientation of the virtual entity and changes in the position and orientation of the user's hand as represented by the rigged smooth-surface model 518. In the case of soft body dynamics the interaction also specifies changes in the shape of the virtual entity and/or rigged smooth-surface model. The feedback engine uses the computed interaction it receives to trigger feedback to the user about the computed interaction. The feedback is any of visual feedback, auditory feedback, haptic feedback and includes combinations of any one or more of these types of feedback. The feedback engine triggers the feedback by sending instructions to equipment in the downstream system 522. For example, by sending instructions to one or more loudspeakers, by sending instructions to wrist or body worn vibration devices or other haptic feedback devices, by sending instructions to graphics engines or other display controllers of the downstream system 522. The instructions are sent over wired or wireless communications links, over a network, or in other ways.

In some examples, the functionality of the tracker 502, the physics engine 514 and the feedback engine 516 is performed, at least in part, by one or more hardware logic components. For example, and without limitation, illustrative types of hardware logic components that are optionally used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

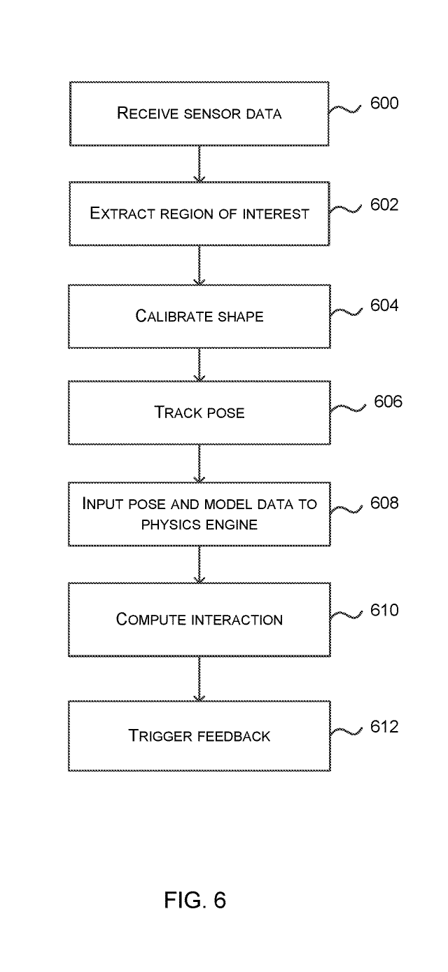

FIG. 6 is a flow diagram of a method at the tracker, physics engine and feedback engine of FIG. 5. Sensor data is received 600 as described above and one or more regions of interest are extracted 602. For example, one region of interest per hand. Optionally the tracker calibrates values of shape parameters of a 3D model of the hand as described in more detail below. Where shape parameter values are available these are applied to the 3D smooth-surface model 518.

For a given region of interest, the tracker operates to track 606 pose of the 3D hand model as described below. It computes values of pose parameters comprising position and orientation of a plurality of joints of the hand model. The pose parameter values are input 608 to a physics engine together with data about the 3D model 608. For example, the physics engine has access to the smooth-surface model and/or to a polygon mesh model which is associated with the smooth-surface model.

The physics engine computes an interaction 610 between one or more virtual entities and the 3D model of the user's hand, taking into account the pose parameter values. For example, the physics engine applies the pose parameter values to the 3D model and computes interactions between the posed 3D model and the virtual entities directly. In some examples the physics engine approximates the posed 3D model using one or more spheres and computes interactions between the one or more spheres and the virtual entity.

In some examples, the physics engine uses data about the skeleton of the 3D model to compute the interaction and does not use data about the surface of the 3D model. This gives good working results. In other examples the physics engine uses data about the surface of the 3D model to compute the interaction. This gives more accurate results than using the skeleton without the surface as mentioned above. In examples where the physics engine uses the surface of the 3D model, because detailed, accurate information is known about the surface as a result of computing the values of the pose parameters of the plurality of joints and optionally the shape parameter values, it is possible to deal with considerable occlusion. That is, the tracker is able to operate even when one or more of the joints of the hand are occluded in the captured sensor data.

The results of the computed interaction are input to the feedback engine which triggers feedback 612 about the computed interaction. The feedback engine sends instructions to one or more downstream systems as described above to trigger the feedback. For example, where the user is wearing a smart watch, wrist worn, body worn or head worn device with vibration motors, the vibration motors operate to give haptic feedback to the user. For example, where loudspeakers are located in the room, or the loudspeakers are located in the headset the feedback engine triggers audio output by sending instructions to the loudspeakers.

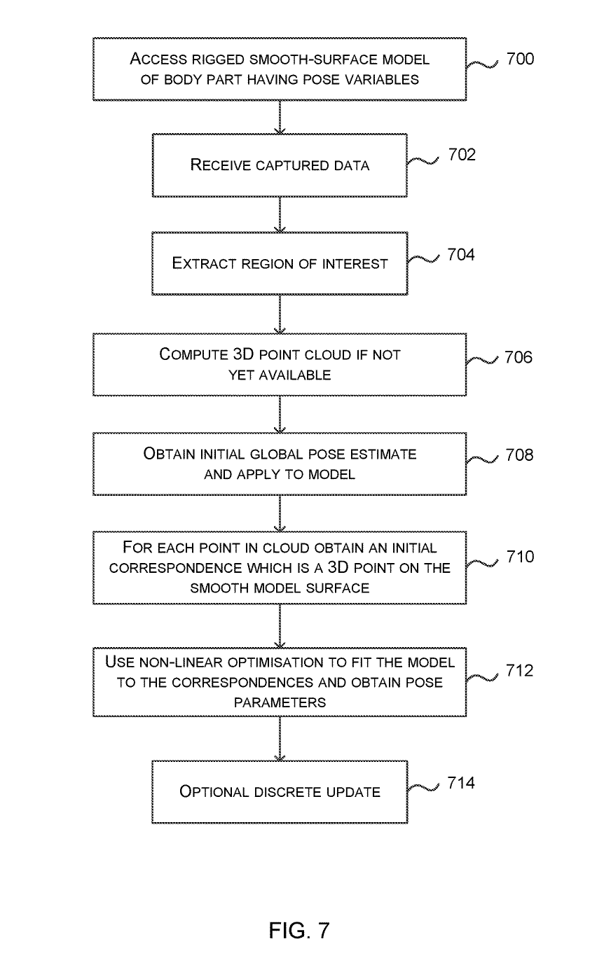

FIG. 7 is a flow diagram of an example method of operation at the tracker of FIG. 5. The tracker accesses 700 a rigged smooth-surface model of a generic hand

The tracker receives captured sensor data 702 as mentioned above and optionally the tracker extracts 304 one or more regions of interest from the captured data.

In some examples, where the region of interest comprises parts of a depth map, the tracker computes 706 a 3D point cloud by back projecting the region of interest. In some cases a 3D point cloud is already available. In some cases no 3D point cloud is used.

Optionally the tracker obtains 708 an initial pose estimate and applies it to the model. For example, by using a value of the pose computed for a previous instance of the captured data. For example, by recording a series of values of the pose computed by the tracker and extrapolating the series to compute a predicted future value of the pose. For example, by selecting a value of the pose at random. For example, by selecting a value of the pose using output of a machine learning algorithm

Optionally the tracker obtains 310 initial correspondence estimates. A correspondence estimate is an indication of a 3D point on the surface of the smooth-surface model corresponding to a captured data point.

In some examples a correspondence is a tuple of values denoted by the symbol u in this document, which specifies a point on the smooth-surface model. The smooth surface itself is 2D and so point u acts in a similar way to a 2D coordinate on that surface. A defining function S is stored at the tracker in some examples and is a function which takes as its input a correspondence u and the pose parameters. The defining function S computes a 3D position in the world that point u on the smooth-surface model corresponds to.

The tracker obtains 710 a plurality of initial correspondence estimates, for example, one for each point in the point cloud, or one for each of a plurality of captured data points. The tracker obtains 710 the initial correspondence estimates by selecting them at random or by using machine learning, or by choosing a closest point on the model given the initial estimate of the global pose, using combinations of one or more of these approaches, or in other ways. In the case that machine learning is used a machine learning system which has been trained using a large amount of training data to derive a direct transformation from image data to 3D model points.

The tracker computes an optimization 712 to fit the model to the captured data. For example, the tracker computes the following minimization beginning from the initial values of the correspondence estimates and the pose parameters where these are available (or beginning from randomly selected values):

$${min}_{θ , {u}_{1} , … {u}_{n}} {\sum }_{i = 1}^{n} ψ ( ‖ {x}_{i} - S ( {u}_{i} ; θ ) ‖ )$$

Which is expressed in words as a minimum over the pose parameters θ and n values of the correspondences u of the sum of a robust kernel ψ(.) applied to the magnitude of the difference between a 3D point cloud point xᵢ and a corresponding 3D smooth model surface point S(uᵢ;θ). Where the robust kernel ψ(.) is a Geman-McClure kernel, a Huber kernel, a Quadratic kernel or other kernel.

The optimization enables correspondence estimation and model fitting to be unified since the minimization searches over possible values of the correspondences u and over possible values of the pose parameters θ. This is unexpectedly found to give better results than an alternative approach of using alternating stages of model fitting and correspondence estimation.

The optimization is non-linear in some examples. The result of the optimization is a set of values of the pose parameters θ including the global pose parameters and the joint positions.

Because the model has a smooth surface it is possible to compute the optimization using a non-linear optimization process. For example, a gradient-based process. Jacobian optimization methods are used in some examples. This improves speed of processing. It may have been expected that such an approach (using a smooth-surfaced model and a non-linear optimization) would not work and/or would give inaccurate results. Despite this it has unexpectedly been found that this approach enables accurate results to be obtained whilst maintaining the improved speed of processing.

A discrete update step is optionally used together with the optimization. This involves using the continuous optimization as mentioned above to update both the pose and the correspondences together, and then using a discrete update to re-set the values of the correspondences using the captured sensor data. The discrete update allows the correspondences to jump efficiently from one part of the object surface to another, for example, from one finger-tip to the next.

The process of FIG. 7 is optionally repeated, for example as new captured data arrives as part of a stream of captured data. In some examples the process of FIG. 7 is arranged to include reinitialization whereby the pose parameters used at the beginning of the optimization are obtained from another source such as the second pose estimator 504. For example, using global positioning sensor data, using another tracker which is independent of the tracker of FIG. 5, using random values or in other ways. Reinitialization occurs at specified time intervals, at specified intervals of instances of captured data, according to user input, according to error metrics which indicate error in the pose values or in other ways. Reinitialization using an independent tracker is found to give good results.

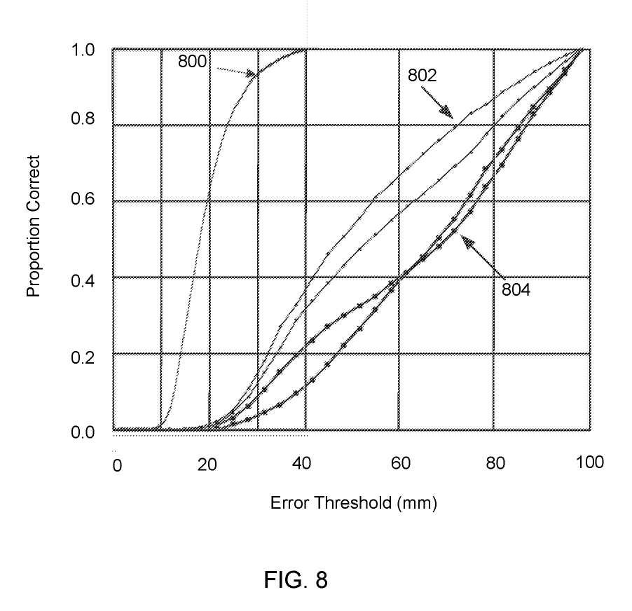

During empirical testing of the tracker 502 labeled data sets were used. For example, captured data labeled with ground truth smooth-surface model points. FIG. 8 is a graph of proportion correct against error threshold in millimeters. Proportion correct is the proportion of captured data points computed by the tracker to have corresponding model points within a certain error threshold distance (in mm) from the ground truth data. As the error threshold increases the proportion correct is expected to go up. Results for the tracker of the present technology are shown in line 800 of FIG. 8. It is seen that the results for the present technology are much more accurate than trackers with results shown in lines 802, 804 of FIG. 8 which do not unify correspondence estimation and model fitting in the same way as described herein.

As mentioned above, the tracker of the present technology computes the pose parameters with improved speed. Rendering approach trackers, using specialist graphics processing units, are found to take around 100 msecs to compute pose parameters from captured data. The present technology is able to compute pose parameters from captured data in 30 msecs using a standard central processing unit (CPU). Rendering approach trackers render an image from a 3D model and compare the rendered image to captured data. This consumes large amounts of computer power, for example requiring hundreds of watts of graphics processing unit (GPU) and CPU power and so is impractical for mobile devices.

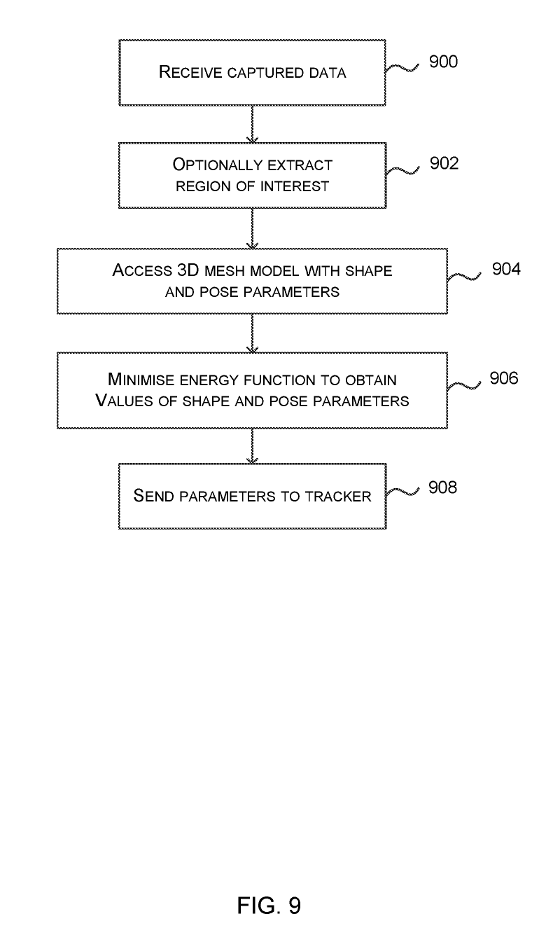

FIG. 9 is a flow diagram of a method of shape calibration at a tracker such as that of FIG. 5. Shape calibration is optional in the method of FIG. 6. Where shape calibration is available the 3D model used by the tracker is calibrated to the particular shape of the user's hand by setting values of shape parameters of the model. By calibrating to the particular shape of the user's hand the tracker is able to further improve accuracy of its performance. An example method of computing values of shape parameters of the 3D model for a particular user is now given. This method is carried out at the tracker itself 506 or at another computing device in communication with the tracker over a wired or wireless link.

The tracker receives 900 the sensor data 504 and optionally extracts 902 a region of interest from the sensor data 504 as mentioned above.

The tracker accesses 904 a 3D mesh model which has shape and pose parameters. The 3D mesh model is of a generic hand and the shape and pose parameters are initially set to default values in some examples so that the 3D mesh model represents a neutral pose and a generic shape. In some examples the mesh model comprises a combination of an articulated skeleton and a mapping from shape parameters to mesh vertices.

In some examples the calibration engine optionally initializes the pose parameter values using values computed from a previous instance of the captured data, or from values computed from another source. However, this is not essential.

The calibration engine minimizes 306 an energy function that expresses how well data rendered from the mesh model and the received sensor data agree. The energy function is jointly optimized over the shape parameters (denoted by the symbol θ) and the pose parameters (denoted by the symbol (β) to maximize the alignment of the mesh model and the captured data. For example, the energy function is given as follows:

$${E}_{gold} ( θ , β ) = \frac{1}{WH} {\sum }_{i = 1}^{W} {\sum }_{j = 1}^{H} {{r}_{ij} ( θ , β )}^{2}$$

With the residual rᵢⱼ(θ,β) for pixel (i,j) defined as a weighted difference between a captured sensor value at pixel i,j minus the value of pixel i,j in the rendered sensor data. The symbol W denotes the width in pixels of the rendered image and the symbol H denotes the height in pixels of the rendered sensor data.

The energy function is expressed in words as:

an energy over pose parameters and shape parameters of a 3D mesh model of an articulated object is equal to an average of the sum of squared differences between captured sensor data points and corresponding data points rendered from the model.

However, it is not straightforward to optimize an energy function of this form because the energy function is not smooth and contains discontinuities in its derivatives. Also, it is not apparent that optimizing this form of energy function would give workable calibration results. It is found in practice that the above energy function is only piecewise continuous as moving occlusion boundaries cause jumps in the value of rendered data points.

Unexpectedly good results are found where the calibration engine is configured to compute the optimization process by using information from derivatives of the energy function. The optimization process is done, in some examples, using a gradient-based optimizer such as the Levenberg-Marquardt optimizer, gradient descent methods, the conjugate gradient method and others. A gradient-based optimizer is one which searches an energy function using search directions that are defined using the gradient of the function at the current point. Gradient-based optimizers require the derivatives of the energy function, and some require the use of Jacobian matrices to represent these derivatives for parts of the energy function. A Jacobian matrix is a matrix of all first-order partial derivatives of a vector valued function.

The calibration engine is configured to compute the optimization process using finite differences in some examples. Finite differences are discretization methods for computing derivatives by approximating them with difference equations. In difference equations, finite differences approximate the derivatives.

In some examples the calibration engine is configured to use a differentiable renderer. That is, the derivatives of the energy function which are to be computed to search for a minimum of the energy function, are computed using a renderer of a graphics processing unit as described in more detail below. This contributes to enabling minimization of the energy function in practical time scales.

In some examples the energy function includes a pose prior energy. The pose prior energy is a term in the energy function which provides constraints on the values of the pose parameters. For example, to avoid unnatural and/or impossible poses from being computed. It is found that use of a pose prior is beneficial where there are occlusions in the captured data. For example, in self-occluded poses during hand tracking where the fingers or forearm are not visible in the rendered image.

In some examples the calibration engine is configured to minimize the energy function where the energy function includes a sum of squared differences penalty. It has been found that using a sum of squared differences penalty (also referred to as an L2 penalty) gives improved results as compared with using a L1 penalty where an L1 penalty is a sum of absolute differences.

In various examples the mesh model includes information about adjacency of mesh faces. However, this is not essential. In some examples the mesh model does not have information about adjacency of mesh faces.

Once the calibration engine has computed the values of the shape parameters it sends 908 those to the tracker.

The tracker receives the shape parameters and applies them to the rigged 3D mesh model and/or the related smooth-surface model. The tracker then proceeds to fit captured sensor data (504 of FIG. 5), to the calibrated rigged model.

Calibration occurs in an online mode or in an offline mode or using hybrids of online and offline modes. In the online mode tracking is ongoing whilst the calibration takes place. In the offline mode tracking is not occurring whilst the calibration takes place.

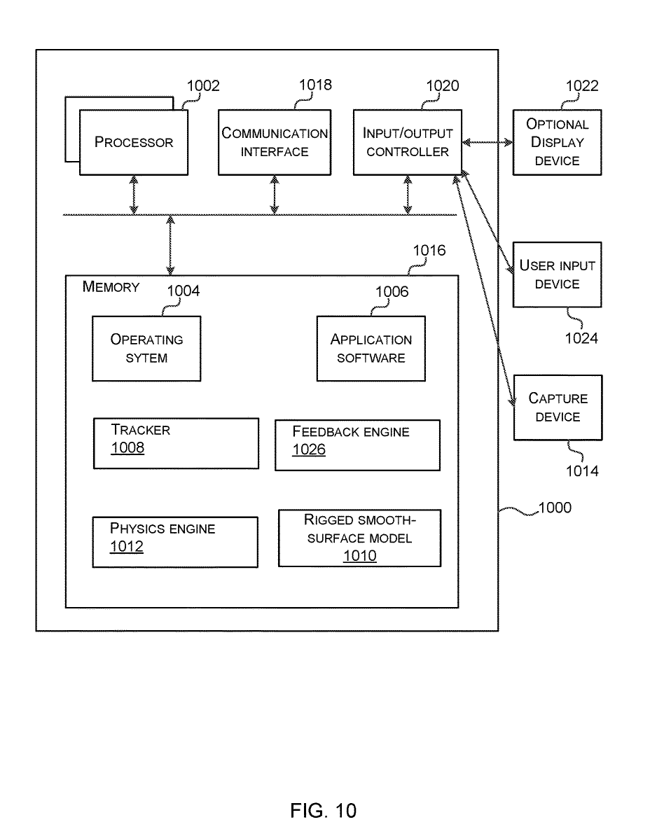

FIG. 10 illustrates various components of an exemplary computing-based device 1000 which is implemented as any form of a computing and/or electronic device, and in which embodiments of a tracker, physics engine and feedback engine are implemented.

Computing-based device 1000 comprises one or more processors 1002 which are microprocessors, controllers or any other suitable type of processors for processing computer executable instructions to control the operation of the device. For example, in order to track pose parameter values of one or more hands and compute interactions between one or more virtual entities and a 3D model of the hand(s) using a physics engine which takes into account the pose parameter values. For example, to trigger feedback to a user about the computed interaction.

In some examples, for example where a system on a chip architecture is used, the processors 1002 include one or more fixed function blocks (also referred to as accelerators) which implement a part of the method of tracking pose parameter values from captured sensor data, and triggering feedback about interactions in hardware (rather than software or firmware). Platform software comprising an operating system 1004 or any other suitable platform software is provided at the computing-based device to enable application software 1006 to be executed on the device. Software comprising a tracker 1008, a physics engine 1012, a feedback engine 1026 is at the computing device in some examples. A rigged smooth-surface model 1010 is stored at the computing based device 1000.

The computer executable instructions are provided using any computer-readable media that is accessible by computing based device 1000. Computer-readable media include, for example, computer storage media such as memory 1016 and communications media. Computer storage media, such as memory 1016, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electric erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is usable to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 1016) is shown within the computing-based device 1000 it will be appreciated that the storage is distributed or located remotely and accessed via a network or other communication link (e.g. using communication interface 1018) in some examples.

The computing-based device 1000 also comprises an input/output controller 1020 arranged to output display information to a display device 1022 which is optionally separate from or integral to the computing-based device 1000. The display device displays one or more virtual entities as described above. The display information optionally provides a graphical user interface in some examples. In some examples, the input/output controller 1020 is also arranged to receive and process input from one or more devices, such as a user input device 1024 (e.g. a mouse, keyboard, camera, microphone or other sensor). A capture device 1014 such as a depth camera, color camera, video camera, web camera, time of flight sensor, range scanner, medical imaging device, or other capture device 1014 provides captured sensor data to the input/output controller 1020. In some examples the user input device 1020 detects voice input, user gestures or other user actions. This user input is used to manipulate one or more virtual reality entities or for other purposes. In an embodiment the display device 1022 acts as the user input device 1024 if it is a touch sensitive display device. The input/output controller 1024 is able to output data to devices other than the display device, e.g. a locally connected printing device in some examples.

Any of the input/output controller 1020, display device 1022 and the user input device 1024 comprise technology which enables a user to interact with the computing-based device in a manner, free from artificial constraints imposed by input devices such as mice, keyboards, remote controls and the like. Examples of such technology that are optionally used include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence.

Alternatively or in addition to the other examples described herein, examples include any combination of the following:

An apparatus comprising:

a memory configured to receive captured sensor data depicting at least one hand of a user operating the control system;

a tracker configured to compute, from the captured sensor data, values of pose parameters of a three dimensional model of the hand, the pose parameters comprising position and orientation of each of a plurality of joints of the hand;

a physics engine storing data about at least one virtual entity ;

wherein the physics engine is configured to compute an interaction between the virtual entity and the three dimensional model of the hand of the user based at least on the values of the pose parameters and data about the three dimensional model of the hand; and

a feedback engine configured to trigger feedback to the user about the computed interaction, the feedback being any one or more of visual feedback, auditory feedback, haptic feedback.

In an example, the physics engine is configured to compute the interaction using one or more spheres which approximate the three dimensional model of the hand to which the values of the pose parameters have been applied.

In an example, the physics engine is configured to compute the interaction using the three dimensional model of the hand, where the three dimensional model of the hand is a model with an associated skeleton comprising the plurality of joints.

In an example, the tracker is configured to compute, from the captured sensor data, values of shape parameters of the three dimensional model such that the three dimensional model is calibrated to an individual shape of the user's hand.

In an example, the tracker is configured to compute values of the pose parameters by calculating an optimization to fit the three dimensional model of the hand to data related to the captured sensor data, where variables representing correspondences between the data and the model are included in the optimization jointly with the pose parameters.

In an example, the three dimensional model is a rigged, smooth-surface model of the hand.

In an example, the tracker is configured to use a gradient-based optimization process to calculate the optimization.

In an example, the physics engine is configured to compute the interaction in the case that the virtual entity is deformable as a soft body as a result of interaction by the three dimensional model of the hand according to the values of the pose parameters.

In an example, the physics engine is configured to compute the interaction in the case that the virtual entity is moved as a rigid body as a result of interaction by the three dimensional model of the hand according to the values of the pose parameters.

In an example, the physics engine is configured to compute the interaction such that the virtual entity appears attached to and able to move on the user's hand.

In an example, the physics engine is configured to send instructions to at least one output device in order to trigger audio and/or haptic feedback.

In an example, the physics engine stores data about the virtual entity in the form of a keyboard of a musical instrument or a computing device, such that the user is able to control the virtual keyboard using the hand.

In an example there is an apparatus comprising:

a memory configured to receive captured sensor data depicting at least one hand of a user operating the control system;

a tracker configured to compute, from the captured sensor data, values of pose parameters of a three dimensional model of the hand, the pose parameters comprising position and orientation of each of a plurality of joints of the hand, where the three dimensional model of the hand has shape parameters set to values calibrated for the individual user;

a physics engine storing data about at least one virtual entity;

wherein the physics engine is configured to compute an interaction between the virtual entity and the three dimensional model of the hand of the user based at least on the values of the pose parameters and data about the three dimensional model of the hand; and

a feedback engine configured to trigger feedback to the user about the computed interaction, the feedback being any one or more of visual feedback, auditory feedback, haptic feedback.

In an example there is a computer-implemented method comprising:

receiving captured sensor data depicting at least one hand of a user operating a control system;

computing, from the captured sensor data, values of pose parameters of a three dimensional model of the hand, the pose parameters comprising position and orientation of each of a plurality of joints of the hand;

computing, using the physics engine, an interaction between a virtual entity and the three dimensional model of the hand of the user based at least on the values of the pose parameters and data about the three dimensional model of the hand; and

triggering feedback to the user about the computed interaction, the feedback being any one or more of visual feedback, auditory feedback, haptic feedback.

In an example the method comprises computing, from the captured sensor data, values of shape parameters of the three dimensional model such that the three dimensional model is calibrated to an individual shape of the user's hand.

In an example the method comprises computing values of the pose parameters by calculating an optimization to fit the three dimensional model of the hand to data related to the captured sensor data, where variables representing correspondences between the data and the model are included in the optimization jointly with the pose parameters.

In an example, the three dimensional model is a rigged, smooth-surface model of the hand.

In an example the method comprises using a gradient-based optimization process to calculate the optimization.

In an example the method comprises computing the interaction such that the virtual entity appears attached to and able to move on the user's hand.

In an example the method comprises storing, at the physics engine, data about the virtual entity in the form of a keyboard of a musical instrument or a computing device, such that the user is able to control the virtual keyboard using the hand.

In examples there is an apparatus comprising:

means for receiving (such as memory 520) captured sensor data depicting at least one hand of a user operating a control system;

means for computing (such as tracker 502), from the captured sensor data, values of pose parameters of a three dimensional model of the hand, the pose parameters comprising position and orientation of each of a plurality of joints of the hand;

means for computing, (such as physics engine 514), an interaction between a virtual entity and the three dimensional model of the hand of the user based at least on the values of the pose parameters and data about the three dimensional model of the hand; and

means for triggering feedback (such as feedback engine 516) to the user about the computed interaction, the feedback being any one or more of visual feedback, auditory feedback, haptic feedback.

The examples illustrated and described herein as well as examples not specifically described herein but within the scope of aspects of the disclosure constitute exemplary means for tracking a user's hands and giving feedback about interaction of the user's hand(s) with one or more virtual entities. For example, the elements illustrated in FIGS. 5 and 10, such as when encoded to perform the operations illustrated in any of FIGS. 6, 7 and 9, constitute exemplary means for receiving captured sensor data, exemplary means for computing values of pose parameters, and exemplary means for triggering feedback.

The term ‘computer’ or ‘computing-based device’ is used herein to refer to any device with processing capability such that it is able to execute instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants and many other devices.

The methods described herein are performed, in some examples, by software in machine readable form on a tangible storage medium e.g. in the form of a computer program comprising computer program code means adapted to perform all the operations of any of the methods described herein when the program is run on a computer and where the computer program is embodied on a computer readable medium. Examples of tangible storage media include computer storage devices comprising computer-readable media such as disks, thumb drives, memory etc. and do not include propagated signals. The software is suitable for execution on a parallel processor or a serial processor such that the method operations are carried out in any suitable order, or simultaneously.

This acknowledges that software is a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions are distributable across a network. For example, a remote computer is able to store an example of the process described as software. A local or terminal computer is able to access the remote computer and download a part or all of the software to run the program. Alternatively, the local computer is able to download pieces of the software as needed, or execute some software instructions at the local terminal and some at the remote computer (or computer network). Those skilled in the art will also realize that by utilizing conventional techniques known to those skilled in the art that all, or a portion of the software instructions is carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above relate to one embodiment or relate to several embodiments. The embodiments are not limited to those that solve any or all of the stated problems or those that have any or all of the stated benefits and advantages. It will further be understood that reference to ‘an’ item refers to one or more of those items.

The operations of the methods described herein are carried out in any suitable order, or simultaneously where appropriate. Additionally, individual blocks are optionally deleted from any of the methods without departing from the spirit and scope of the subject matter described herein. Aspects of any of the examples described above are optionally combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. An apparatus comprising:
a memory configured to receive captured sensor data depicting at least one hand of a user operating a control system;
a tracker configured to compute, from the captured sensor data, values of pose parameters of a three dimensional model of the hand, the pose parameters comprising position and orientation of each of a plurality of joints of the hand;
a physics engine storing data about at least one virtual entity;
wherein the physics engine is configured to compute an interaction between the virtual entity and the three dimensional model of the hand of the user based at least on the values of the pose parameters and data about the three dimensional model of the hand; and
a feedback engine configured to trigger feedback to the user about the computed interaction, the feedback being any one or more of visual feedback, auditory feedback, haptic feedback.

2. The apparatus of claim 1 wherein the physics engine is configured to compute the interaction using one or more spheres which approximate the three dimensional model of the hand to which the values of the pose parameters have been applied.

3. The apparatus of claim 1 wherein the physics engine is configured to compute the interaction using the three dimensional model of the hand, where the three dimensional model of the hand is a model with an associated skeleton comprising the plurality of joints.

4. The apparatus of claim 1 wherein the tracker is configured to compute, from the captured sensor data, values of shape parameters of the three dimensional model such that the three dimensional model is calibrated to an individual shape of the user's hand

5. The apparatus of claim 1 wherein the tracker is configured to compute values of the pose parameters by calculating an optimization to fit the three dimensional model of the hand to data related to the captured sensor data, where variables representing correspondences between the data and the model are included in the optimization jointly with the pose parameters.

6. The apparatus of claim 5 wherein the three dimensional model is a rigged, smooth-surface model of the hand

7. The apparatus of claim 5 wherein the tracker is configured to use a gradient-based optimization process to calculate the optimization.

8. The apparatus of claim 1 wherein the physics engine is configured to compute the interaction in the case that the virtual entity is deformable as a soft body as a result of interaction by the three dimensional model of the hand according to the values of the pose parameters.

9. The apparatus of claim 1 wherein the physics engine is configured to compute the interaction in the case that the virtual entity is moved as a rigid body as a result of interaction by the three dimensional model of the hand according to the values of the pose parameters.

10. The apparatus of claim 1 wherein the physics engine is configured to compute the interaction such that the virtual entity appears attached to and able to move on the user's hand

11. The apparatus of claim 1 wherein the physics engine is configured to send instructions to at least one output device in order to trigger audio and/or haptic feedback.

12. The apparatus of claim 1 wherein the physics engine stores data about the virtual entity in the form of a keyboard of a musical instrument or a computing device, such that the user is able to control the virtual keyboard using the hand

13. An apparatus comprising:
a memory configured to receive captured sensor data depicting at least one hand of a user operating the control system;
a tracker configured to compute, from the captured sensor data, values of pose parameters of a three dimensional model of the hand, the pose parameters comprising position and orientation of each of a plurality of joints of the hand, where the three dimensional model of the hand has shape parameters set to values calibrated for the individual user;
a physics engine storing data about at least one virtual entity;
wherein the physics engine is configured to compute an interaction between the virtual entity and the three dimensional model of the hand of the user based at least on the values of the pose parameters and data about the three dimensional model of the hand; and
a feedback engine configured to trigger feedback to the user about the computed interaction, the feedback being any one or more of visual feedback, auditory feedback, haptic feedback.

14. A computer-implemented method comprising:
receiving captured sensor data depicting at least one hand of a user operating a control system;
computing, from the captured sensor data, values of pose parameters of a three dimensional model of the hand, the pose parameters comprising position and orientation of each of a plurality of joints of the hand;
computing, using the physics engine, an interaction between a virtual entity and the three dimensional model of the hand of the user based at least on the values of the pose parameters and data about the three dimensional model of the hand; and
triggering feedback to the user about the computed interaction, the feedback being any one or more of visual feedback, auditory feedback, haptic feedback.

15. The method of claim 14 comprising computing, from the captured sensor data, values of shape parameters of the three dimensional model such that the three dimensional model is calibrated to an individual shape of the user's hand.

16. The method of claim 14 comprising computing values of the pose parameters by calculating an optimization to fit the three dimensional model of the hand to data related to the captured sensor data, where variables representing correspondences between the data and the model are included in the optimization jointly with the pose parameters.

17. The method of claim 14 wherein the three dimensional model is a rigged, smooth-surface model of the hand.

18. The method of claim 14 comprising using a gradient-based optimization process to calculate the optimization.

19. The method of claim 14 comprising computing the interaction such that the virtual entity appears attached to and able to move on the user's hand.

20. The method of claim 14 comprising storing, at the physics engine, data about the virtual entity in the form of a keyboard of a musical instrument or a computing device, such that the user is able to control the virtual keyboard using the hand.
